(19) United States
(12) Patent Application Publication
(10) Pub. No.: US 2026/0268016 A1
(43) Pub. Date: Sep. 10, 2026

(54) APP-SPECIFIC LEARNING WITH PRIVACY PRESERVING

(71) Applicant: ANAGOG LTD., Tel Aviv (IL)

(72) Inventor: Gil Levy, Rehovot (IL)

(21) Appl. No.: 19/166,076

(22) PCT Filed: Apr. 21, 2024
(86) PCT No.: PCT/IL2024/050398

§ 371 Date: Sep. 17, 2025

Related U.S. Application Data
(60) Provisional application No. 63/499,736, filed on May 3, 2023.

(51) Int. Cl. G06F 21/62; G06N 20/00

(52) U.S. Cl. CPC G06F 21/6245; G06N 20/00

(57) ABSTRACT

A method, system, computerized apparatus and computer program product for training a specific model in a computerized environment with multiple user devices. Each user device executes a generic model that is configured to classify a user thereof into segments based on data obtained at the user device, each segment representing audience characterized by attributes. Data obtained from a specific application forms a training set for the specific model, comprising pairs of a ground truth label used by the application and a respective set of segments of a user device for which the ground truth label is deemed applicable by the application. The specific model may be trained on this training set, and applied in concatenation with the generic model, to predict a label for a user device based on classification determined by the generic model without being privy to the data obtained at the user device.

### CROSS-REFERENCE TO RELATED APPLICATION

This application claims the benefit of provisional U.S. patent application No. 63/499,736, entitled “LEARNING WITH PRIVACY” filed May 3, 2023, which is hereby incorporated by reference in its entirety without giving rise to disavowment.

### TECHNICAL FIELD

The present disclosure relates to machine learning in general, and to app-specific machine learning while preserving user privacy, in particular.

### BACKGROUND

Machine learning algorithms have emerged as powerful tools across various industries, enabling tasks ranging from data analysis to predictive modeling. However, the effectiveness of these algorithms relies on access to training data, that often, encompasses sensitive or private information, such as Personal Identifiable Information (PII), health records, or financial data, posing significant challenges related to privacy and data protection.

In conventional machine learning approaches, training models typically involve direct access to raw data, raising concerns about unauthorized access, data breaches, and misuse of private information. Moreover, regulatory frameworks impose strict guidelines on the collection, storage, and utilization of personal data, further complicating the development and deployment of machine learning solutions.

As the demand for privacy-preserving technologies grows, there is a pressing need for innovative approaches that can reconcile the benefits of machine learning with stringent privacy requirements. Addressing these concerns is critical to fostering trust among users and stakeholders, facilitating the ethical and responsible deployment of machine learning systems, and ensuring compliance with evolving regulatory landscapes.

### BRIEF SUMMARY

One exemplary embodiment of the disclosed subject matter is a method for training a first app-specific model in a computerized environment that comprises a plurality of user devices, the method comprising: executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments; obtaining, from a first application, a first training set to be used for training the first app-specific model, the first training set includes pairs of a ground truth label used by the first application and a respective set of segments of a user device for which the ground truth label is deemed applicable by the first application; and training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.

Optionally, the method further comprises obtaining, from a second application, a second training set to be used for training a second app-specific model, the second training set includes pairs of a ground truth label used by the second application and a respective set of segments of a user device for which the ground truth label is deemed applicable by the second application; and training, based on the second training set, the second app-specific model, whereby the second app-specific model is configured to predict a label for a user device based on classification determined by the generic model without being privy to the data obtained at the each user device.

Optionally, the first app-specific model is configured to predict a first label for a specific user device, the second app-specific model is configured to predict a second label for the specific user device, wherein the first label and the second label are different.

Optionally, the first app-specific model and the second app-specific model are configured to predict a specific label of a same name, wherein the first app-specific model is configured to predict the specific label for a specific user device while the second app-specific model is configured to not predict the specific label for the specific device, whereby different label prediction is enabled for different applications.

Optionally, the specific label of the same name relates to at least one of Life Time Value (LTV) of a respective user, a churn likelihood of the respective user, and a promoter score of the respective user.

Optionally, the data obtained at each user device and utilized by the generic model comprises private data of the respective user of the each user device, whereby said training is performed without being privy to the private data, whereby the first app-specific model is configured to perform predictions without utilizing the private data directly.

Optionally, the private data comprises at least one of: location data; sensor reading data; and browsing history data.

Optionally, said training the first app-specific model is performed on a cloud server, wherein in response to said training, the first application is configured to utilize the app-specific model in devices in which the first application is deployed.

Optionally, said training is performed on a computing device, the computing device is different than the plurality of user devices, wherein the respective set of segments utilized for training the first app-specific model is provided in an encrypted manner, whereby preventing the computing device from gaining access to confidential data of the first application.

Optionally, a value of a predicted segment is encrypted.

Optionally, a name of a predicted segment is encrypted

Another exemplary embodiment of the disclosed subject matter is a system comprising: a plurality of user devices, each individual user device of said plurality of user devices executing a generic model, the generic model being configured to classify a user of the each individual user device into one or more segments based on data obtained at the each individual user device, each segment of the one or more segments represents an audience segment that is characterized by one or more attributes, whereby each user device is potentially classified into a different set of segments; a server configured to obtain data from said plurality of user devices and train app-specific models to be utilized by said plurality of user devices, wherein said server is configured to: obtain, from an application executed on at least a portion of the plurality of user devices, a training set to be used for training an app-specific model, the training set includes pairs of a ground truth label used by the application and a respective set of segments of user devices for which the ground truth label is deemed applicable by the application; and train, based on the training set, the app-specific model, wherein the app-specific model is configured to be utilized in concatenation with the generic model, the app-specific model is configured to predict a label for a user device based on classification determined by the generic model without being privy to the data obtained at the user device.

Yet another exemplary embodiment of the disclosed subject matter is a computerized apparatus having a hardware processor, the hardware processor being coupled to a memory, the hardware processor being adapted to perform the steps of: executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments; obtaining, from a first application, a first training set to be used for training the first app-specific model, the first training set includes pairs of a ground truth label used by the first application and a respective set of segments of a user device for which the ground truth label is deemed applicable by the first application; and training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.

Optionally, the hardware processor is further adapted to perform the steps of: obtaining, from a second application, a second training set to be used for training a second app-specific model, the second training set includes pairs of a ground truth label used by the second application and a respective set of segments of a user device for which the ground truth label is deemed applicable by the second application; and training, based on the second training set, the second app-specific model, whereby the second app-specific model is configured to predict a label for a user device based on classification determined by the generic model without being privy to the data obtained at the each user device.

Yet another exemplary embodiment of the disclosed subject matter is a computer program product comprising a non-transitory computer readable storage medium retaining program instructions, which program instructions when read by a processor, cause the processor to perform a method comprising: executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments; obtaining, from a first application, a first training set to be used for training the first app-specific model, the first training set includes pairs of a ground truth label used by the first application and a respective set of segments of a user device for which the ground truth label is deemed applicable by the first application; and training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show flowchart diagrams of methods, in accordance with some exemplary embodiments of the disclosed subject matter;

FIG. 2 shows a schematic illustration of an exemplary architecture, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

One technical problem dealt with by the disclosed subject matter is to facilitate supervised training of application-specific Machine Learning (ML) models while maintaining user privacy. Generating, maintaining and training ML models, and particularly application-specific ML models, may require access to training data, which often contains PII or other sensitive data of the user of the application or the device. Automated learning processes, such as supervised training of ML models, while simultaneously safeguarding user privacy may be demanded. The challenge addressed by the disclosed subject matter revolves around enabling the utilization of application-specific data for training and application of ML models tailored to particular tasks or applications, all while ensuring that PII and other private information remain protected from exposure to the underlying platform or any unauthorized parties. On the other hand, conducting training of ML models directly on user devices to preserve user privacy can be costly and resource-intensive in terms of computational power and resources.

In some exemplary embodiments, customer engagement platforms, such as operated by ANAGOG™, may enable their clients, mobile app developers and other owners of specific programs, apps, web-based services, or the like (generally referred to as “app”), to gather information about users of such apps. The platforms may utilize advanced algorithms and techniques to collect data from user devices while prioritizing user privacy and data protection. The data may include various insights about the users such as demographic data, location data, behavior patterns, preferences, and other relevant information that can help app developers and businesses better understand their users and enhance their services or products. While the platform may be configured to classify or label end users based on general parameters, such as geographical location, demographic patterns, or the like, the app owners may wish to classify the users according to specific or additional labels that may be domain-specific, such as specific shopping habits, specific demographic data related to specific use of the application, certain indicators in relation to a particular characteristic or metrics, or the like. As an example, “high-in-app-spender” label may be relevant to shopping app but not to free gaming app. As another example, “driver/rider” label may be relevant to driving-related apps but not to shopping apps. As yet another example, loyalty apps associated with a food chain may label end users as “likely to convert to member”, which may not necessarily be relevant in other domains. Additionally, or alternatively, even when the specific labels are identical, the relevant cohorts may be different for different apps. As an example, “high-in-app-spender” in a convenient store app may be characterized differently than those with the same label in an app of a luxury brand. Furthermore, in some exemplary embodiments, the app owner may wish to preserve its end-user's privacy and avoid divulging private information to the platform.

One technical solution is to perform a two-phase learning approach for training machine learning models while preserving user privacy. In the first learning phase, a generic on-device model may be trained based on data obtained from user devices including potentially sensitive or private data, while excluding identifying information of users of the user devices. The generic on-device model may be configured to classify a user of each user device into one or more segments based on data obtained at the user device, such as during browsing, during activity of the user, or the like. The generic on-device model may be trained based on information available to the platform, collected by multiple user devices. The generic on-device model may be trained at the cloud, on a server, or the like. The generic on-device model may then be downloaded and executed on different user devices. In some cases, the generic on-device model may be generic for all different apps supported by the platform. Additionally, or alternatively, several generic on-device model may be available, each for different potential usages or apps.

In the second learning phase, app-specific on-device models may be trained for each app using app-specific data gathered from user devices. In some exemplary embodiments, app-specific data may be collected for each app, from the user devices. The app-specific data may be obtained by applying the generic model on data at the user device to obtain respective sets of segments of user devices, and the respective data associated thereto obtained by the app-specific logic. The app-specific data may be utilized to train app-specific on-device model in concatenation with the generic on-device model. Accordingly, the app-specific on-device model may be trained based on data from the plurality of user devices (e.g., the training data of the generic model), without being privy to the sensitive training data from the plurality of user devices.

It may be noted that the first training phase may be generic and be implemented before any of the apps are available. The second training phase may be app-specific and may be based on initial data gathering performed by the app itself. It may further be noted that using the two different models, the timespan required to achieve the learning of the target labels may be reduced, as the first phase training is performed once for all apps that use the same generic model. The amount of data required to perfect the generic model may be large and may not be available for any one specific app. The data available from the app itself (or from a predecessor data gathering agent implemented on behalf of the app owner) may be more limited but enable the prediction of the target label, given the predicted segments and other predicted attributes that the generic model provides.

One technical effect of utilizing the disclosed subject matter is to enable supervised training of app-specific machine learning models while maintaining user privacy. This is achieved by training app-specific models without compromising sensitive data or personally identifiable information (PII). By utilizing app-specific models trained on user segments, applications can deliver personalized experiences tailored to individual user characteristics, preferences, and behaviors. This leads to enhanced user engagement, satisfaction, and retention. Furthermore, the disclosed architecture allows for flexibility in deploying and utilizing trained models across different applications and user devices. App-specific models can be published and integrated into various applications, enhancing their functionality and predictive capabilities. This flexibility enables developers to leverage machine learning models to deliver innovative features and improve user experiences.

Another technical effect of utilizing the disclosed subject matter is to enable an efficient training of app-specific machine learning models. The two-phase learning approach optimizes the training process by separating the training of a generic on-device model from app-specific models. This reduces the time required to achieve learning of target labels and minimizes the computational resources needed for training. By leveraging a generic model for multiple apps and then refining with app-specific data, the method streamlines the model training process.

Yet another technical effect of utilizing the disclosed subject matter is to enhance data security in training of app-specific machine learning models. The encryption of training data, including user segments and app-specific labels, enhances data security during transmission and storage. By encrypting sensitive information, the method prevents unauthorized access to confidential data and mitigates the risk of data breaches or leaks. This ensures that only authorized parties can access and interpret the training data, maintaining the confidentiality of user information.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

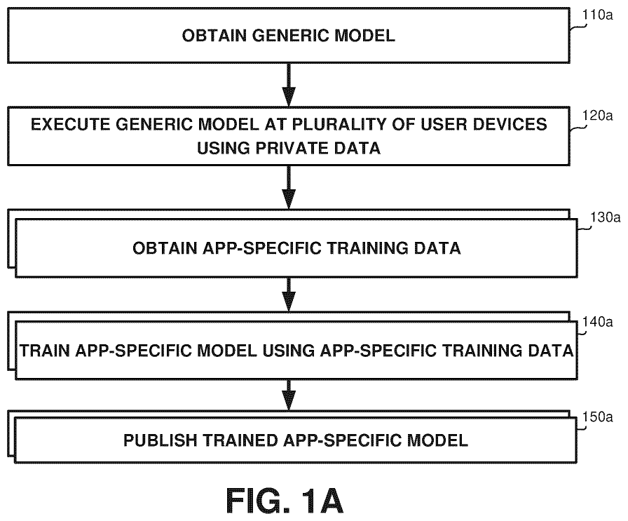

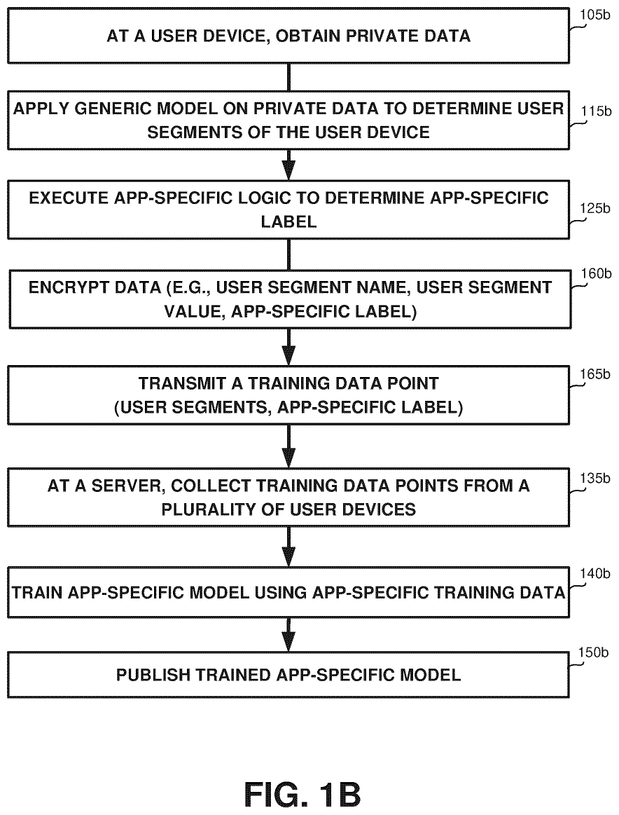

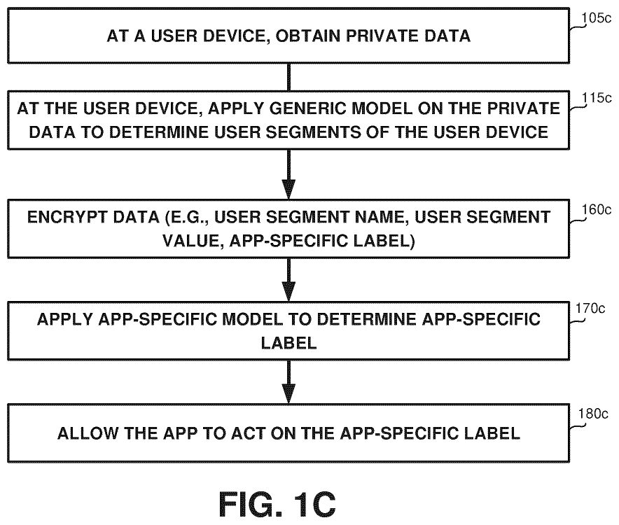

Referring now to FIGS. 1A-1C showing flowchart diagrams of a method, in accordance with some exemplary embodiments of the disclosed subject matter.

The following steps of FIG. 1A, describe some of the steps of an exemplary method for training a plurality of app-specific models in a computerized environment that comprises a plurality of user devices. Steps 130a-150a may be repeated for each app-specific model separately, in parallel, or the like. In some exemplary embodiments, each user device of the plurality of user devices may execute one or more applications or programs, also referred to as apps. In some exemplary embodiments, the plurality of user devices may be connected to a platform configured to manage and analyze user engagement and activity in the computerized environment. Each user device may decide whether to give the platform a full access to the private data thereof.

On Step 110a, a generic model may be obtained. The generic model may be a ML model configured to classify users of user devices into one or more segments based on raw data of the users. The segments obtained by the generic model classification may represent audience segments, each of which is characterized by one or more attributes of the users belonging to the respective audience segment.

In some exemplary embodiments, the generic model may be generated independently from the process of generating or training the plurality of app-specific models (e.g., in Step 140a or in the processes described in FIGS. 1B and 1C), in advanced, before any app being installed on the user devices, or the like. It may be noted that the generic model may be generic for all different apps supported by the platform or any app that may be installed on a user device of the plurality of user devices. However, in some cases, several generic model may be generated, each for different potential usages or different types of apps, or the like.

In some exemplary embodiments, the generic model may be trained at a cloud, on a server, or the like, and then may be downloaded to each of the user devices. The generic model may be trained based on data available to the platform, such as general data, or data provided by the plurality of user devices to the platform, or the like. Additionally, or alternatively, a first learning phase, in which the generic on-device model is trained may be implemented, e.g., in Steps 110a and 120a, to enable providing app-specific training data in Step 130a for training app-specific models in a second training phase without compromising privacy of the user devices. The generic on-device model may be based on raw data obtained from the plurality of user devices that is potentially sensitive, including data provided in rational data types.

On Step 120a, the generic model may be executed on each user device of the plurality of user devices. The generic model may be configured to classify a user of each user device into one or more segments based on data obtained at the user device. Each user device may be potentially classified into a different set of segments.

In some exemplary embodiments, the data obtained at each user device and utilized by the generic model may comprises private data of the respective user of the user device. As an example, the data may comprise sensor data such as accelerometer readings, GPS coordinates, or the like. As another example, the data may comprise health metrics data, such as physical activity, health records, or the like. As yet another example, the data may comprise financial transaction data, such as purchase history, spending patterns, account balances, or the like. As yet another example, the data may comprise activity logs, including user interactions with applications, browsing history, app usage duration, or the like. As yet another example, the data may comprise communication data, such as call logs, text message logs, email metadata, or the like. As yet another example, the data may comprise location data, such as geospatial coordinates, movement patterns, frequently visited places, or the like. As yet another example, the data may comprise social media interactions, including likes, shares, comments, followers, or the like. As yet another example, the data may comprise vehicle telemetry data, such as speed, fuel consumption, engine status, or the like.

Accordingly, it may be required to perform the training of each app-specific model without being privy to the private data, and perform predictions without utilizing the private data directly. Instead, training of the app-specific may be performed based on output of the generic model.

On Step 130a, app-specific training data of may be obtained, for each app-specific model being trained. In some exemplary embodiments, a training dataset that comprises training data for an app-specific model may be obtained from the respective application at the respective user device. The training set comprise pairs of a ground truth label used by the application and a respective set of segments of a user device for which the ground truth label is deemed applicable by the application.

As an example, the training data may comprise pairs of segments indicating the demographic information of the user (age, gender, etc.), current activity of the user (e.g., walking), trends of the users (e.g., walks less this week than usual), habits (e.g., walks often), or the like. Using the predicted information, together with an app-specific label, the platform may train the app-specific model to predict app-specific labels, such as, “big-spender” label, “about to churn” label.

It may be noted that the app-specific training data may be reported by the user devices to the platform, in privacy level selected by the user device. As it may be desired to prevent the platform from gaining access to the sensitive or private data, the app-specific training may comprise obfuscations or other encryptions method of the generic data, such as the segments created by the generic model as well as app-specific labels.

On Step 140a, the app-specific model may be trained based on the training set. In some exemplary embodiments, training of the app-specific model may be performed on a cloud server.

Additionally, or alternatively, training may be performed on a computing device different than the plurality of user devices. In such a case, the respective set of segments utilized for training the app-specific model may be provided to the computing in an encrypted manner, in order preventing the computing device from gaining access to confidential data of the application. In some cases, the encryption may be performed on the values of the segments predicted by the generic model. Additionally, or alternatively, the encryption may be performed on the names of the segments predicted by predicted by the generic model, the semantic meaning of the segments predicted by predicted by the generic model, or the like.

In some exemplary embodiments, Steps 130a and 140a may be repeated or performed periodically, or separately for each app installed on each user device in the computerized environment. Additionally, or alternatively, Steps 130 and 140 may be performed for each client of the platform, for each app owner or the like. Each application may be configured to provide a training set to be used for training a designated app-specific model. The training set may include pairs of a ground truth label used by the application and a respective set of segments of a user device for which the ground truth label is deemed applicable by the application. The app-specific model may be trained based on the training set, and utilized to predict labels for user devices based on classifications determined by the generic model without being privy to the data obtained at the user devices.

On Step 150a, the trained app-specific models may be published. The trained app-specific models may become available for utilization within the respective applications associated with the plurality of user devices. This step ensures that the trained models become accessible and ready to be deployed to enhance the functionality and user experience of the applications.

In some exemplary embodiments, the app-specific models may be retained in designated repositories or databases where they can be accessed by the platform, application developers, app owners, or the like. Additionally, or alternatively, the app-specific models may be made accessible for utilization within the applications associated with the plurality of user devices. Application developers can integrate the app-specific models into their applications to leverage their predictive capabilities and enhance user engagement, personalization, or other targeted functionalities.

The following steps of FIG. 1b, describe some of the steps of an exemplary method for training an app-specific model in a computerized environment that comprises a plurality of user devices, while encrypting the training data utilized for training such app-specific models (Step 160b).

On Step 105b, private data may be obtained at a user device. In some exemplary embodiments, the private data comprise information the that users generate or interact with while using the device, such as identifying information (names, email addresses, phone numbers, social security numbers, or any other data that directly identifies an individual), biometric data, location information, communication data, or the like. The private data may include various types of information, such as sensor readings, activity logs, health metrics, location readings, communication records, or the like.

The private data may serve as input for subsequent steps in the training pipeline, ultimately contributing to the development of app-specific models while maintaining user privacy and confidentiality.

On Step 115b, the generic model may be applied on the private data obtained from the user device in order to determine segments of the user device. In some exemplary embodiments, the generic model may process the private data input and analyze it to identify relevant segments or clusters within the data. These segments represent groups of users who share similar characteristics, behaviors, or attributes based on the features extracted from the private data. Each segment outputted by the genetic model may represent a different category or classification of users, allowing for the differentiation of users based on their respective data profiles.

On Step 125b, app-specific logic may be applied to determine app-specific label based on the segments identified by the generic model. In some exemplary embodiments, the app-specific logic may comprise specific rules, algorithms, or processes applied by the application itself to generate labels or predictions relevant to its functionality. The app-specific logic may be applied to the segments of the user device identified using the generic model, to determine the appropriate app-specific label. This label may represent various attributes, behaviors, preferences, or predictions specific to the application's domain or purpose. The app-specific label generated in this step may be tailored to the context of the application and its intended use case. As an example, if the application is a retail app, the app-specific label may indicate the user's shopping preferences, buying habits, or product preferences. As another example, for a health and fitness app, the label may represent the user's fitness goals, exercise routines, or dietary preferences. Once the app-specific label is determined based on the segments and app-specific logic, this labeled data may then prepared for training the app-specific model. In many cases, the training data may be structured as tuples containing the segment information along with the corresponding app-specific label. These tuples may serve as input to the training process, allowing the model to learn the relationship between segments and app-specific labels.

On Step 160b, the data may be encrypted at the user device before being transmitted for training at the server side. This encryption process aims to protect the privacy and confidentiality of the data while still allowing it to be utilized for training the app-specific model. The encryption may be performed on the following components of the data or any combination thereof: user segment name, user segment value, and the app-specific label. By encrypting these components of the data, the user device adds an additional layer of security to the training data before it is transmitted to the server side for model training. This helps mitigate the risk of unauthorized access or data breaches, thereby enhancing the overall privacy and security of the training process.

In some exemplary embodiments, the user segment name or identifier associated with each segment identified by the generic model. Encrypting the segment names helps ensure that sensitive information about the segmentation may be encrypted before transmitting the app-specific training data, to protect from unauthorized access or interception during transmission. Additionally, or alternatively, the value of the user segment predicted by the generic model, e.g., the actual data or information associated with each segment, such as demographic characteristics, user behaviors, or activity patterns, may be encrypted. Encrypting the segment values helps safeguard the privacy of individual users by preventing unauthorized parties from accessing or interpreting the raw data.

Additionally, or alternatively, the app-specific label may be encrypted. This represents the output or prediction generated by the app-specific logic based on the segments identified for each user device. Encrypting the app-specific labels ensures that sensitive information about users' interactions with the application is kept confidential and cannot be easily deciphered by unauthorized entities.

It may be noted that the features or the labels may be encrypted by the edge device in a way that the processing party or the server does not know the meaning of each attribute but a model can still be created and downloaded to the edge devices and prediction can run on the edge devices without the need of the processing party knowing the meaning of the model input.

On Step 165b, a training datapoint may be transmitted. The training datapoint may comprise a pair of a user segment and an app-specific label, or an encryption thereof.

On Step 140b, the app-specific model may be trained based on the training set including the training datapoint, similar to Step 140a.

On Step 150b, the trained app-specific models may be published, similar to Step 150a.

The following steps of FIG. 1c, describe some exemplary steps of application and utilization of the trained app-specific models in concatenation with the generic model.

In response to training the app-specific model, the application may be configured to utilize the app-specific model in devices in which the application is deployed. In some exemplary embodiments, the app-specific model may be provided to the user device in which it may be utilized in concatenation with the generic model.

On Step 105c, private data may be obtained at the user device. The private data may be utilized as an input for the generic model in Step 115c, to determine segments of the user device, or other generic information about the user device or its user.

On Step 160c, the data, e.g., the segments of the user device and may be encrypted at the user device.

On Step 170c, the trained app-specific model may be applied to determine an app-specific label. In some exemplary embodiments, the encrypted predicted information may be fed to the app-specific model to provide a prediction of the app-specific labels.

In some exemplary embodiments, the trained app-specific model may be configured to predict an app-specific label for the user device based on classification (e.g., segments of the user, or encryption thereof) determined by the generic model without being privy to the data obtained at the user device. Additionally, or alternatively, different app-specific models of different apps may be configured to predict different labels for a specific user device, despite apparently having the same attribute or segmentation.

Additionally, or alternatively, one app-specific models may predict a specific label of for a specific user device while another app-specific model is configured to not predict the specific label for the specific device, whereby different label prediction is enabled for different applications. The specific label of the same name relates to at least one of Life Time Value (LTV) of a respective user, a churn likelihood of the respective user, and a promoter score of the respective user.

In some cases, the same label may be utilized by different apps. However, data may not be shared between the different apps and the models may be different, and such features may be domain-specific and potentially different for the same user in different apps.

On Step 180c, the app-specific label may be utilized by the app. In some exemplary embodiments, the app may tailor its functionality or behavior according to the user's characteristics, preferences, or predicted actions, in accordance with the predicted outcome of the app-specific model. The app-specific label which represent various user attributes or behaviors predicted by the app-specific model, may be used by the application to customize its features, content, or interactions for the user, in order to enhance user experience, engagement, or satisfaction with the application.

As an example, in an e-commerce app, if the app-specific model predicts that a user is a “big-spender” based on their previous shopping behavior and other relevant data, the application may prioritize showing high-end or premium products to this user, offer personalized discounts or promotions on luxury items, or provide tailored recommendations based on their spending habits. As another example, in a fitness tracking app, if the app-specific model predicts that a user has a “high fitness commitment” based on their consistent exercise routines and progress, the application may congratulate the user on their achievements, suggest more challenging workout routines or goals, or provide rewards for reaching milestones such as completing a certain number of workouts in a week. As yet another example, in a music streaming app, if the model predicts that a user is a “jazz enthusiast” based on their listening history and preferences, the application may curate personalized playlists featuring jazz music, recommend upcoming jazz events or concerts in their area, or highlight new jazz releases from their favorite artists.

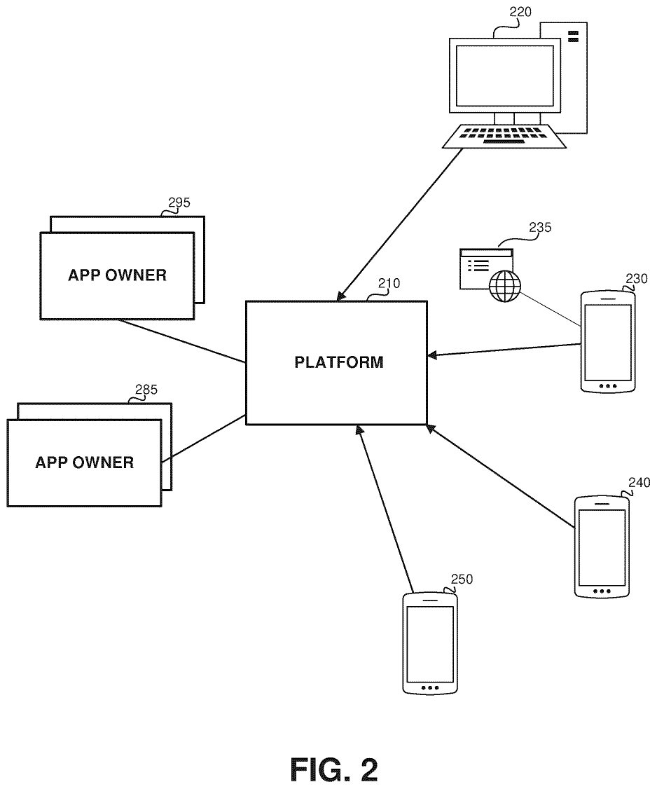

Referring now to FIG. 2 showing a schematic illustration of an exemplary architecture, in accordance with some exemplary embodiments of the disclosed subject matter.

In some exemplary embodiments, a Platform 210 may be connected to a plurality of edge devices, also referred to as user devices, such as Device 220, Device 230, Device 240, Device 250, or the like. Platform 210 may be configured to obtain and analyze data usage of users of such user devices. Platform 210 may be further configured to provide personalization and targeted campaigns of connected clients thereof, such as one or more App owners 295, 285 thereof, for users of the connected devices, in accordance with the analysis of the user engagement without requiring that any personal data will be shared outside of the device.

In some exemplary embodiments, each of the edge Devices 220-250 may be configured to transmit data to Platform 210. In order to keep end users or edge devices data privacy, the data may be sent without a user ID, a Universally Unique Identifier (UUID) or any other combination of data which might constitute PII or unique identifiers that directly link the data to specific user or devices. Instead, the data may be anonymized or aggregated in a way that preserves user privacy while still allowing for analysis and learning in a cloud-based environment.

In some exemplary embodiments, the data obtained from edge Devices 220-250 may be utilized to train ML models on the cloud that may explain the impact of various edge device data or attributes on the labeled data, to run prediction models on new data, to cluster the collected data, to provide prediction models to the edge devices in order to run the prediction on the edge devices in inference mode, or the like.

In some exemplary embodiments, the data collected from edge Devices 220-250 may comprise various types of data. As an example, Edge Device 220 may provide the following data: “high-LTV: true, Income-level: med, car-owner: true, hours-at-home: 11” that comprises binary data, categorial data, Boolean data, and numerical data. “high-LTV: true” represents binary data where the value is either true or false, indicating a yes or no, on or off, or similar dichotomous state. In this case, “high-LTV” likely stands for “high lifetime value,” suggesting that the user associated with this data entry has a high lifetime value, possibly in the context of customer value or engagement. As another example, “Income-level: med” represents categorical data, where the value falls into one of several categories or groups. In this example, “med” presumably stands for “medium,” indicating a moderate-income level. “Hours-at-home: 11” represents numerical data, specifically discrete numerical data. The generic on-device model may be configured to operate on any type of data type, including rational data types, numeric, Boolean, combination of types, or the like.

Additionally, or alternatively, data sent by Devices 220-250 to Platform 210 may be encrypted before being sent. As an example, instead of transmitting “high-LTV: true, Income-level: med, car-owner: true, hours-at-home: 11”, Device 220 may transmit “high-LTV: true, F1=0x3F, F2=0xFF, F3=0x00 . . . ”, Device 230 may transmit “high-LTV: false, F1=0x01, F2=0x2D, F3=0xA2 . . . ”, Device 240 may transmit “high-LTV: true, F1=0x01, F2=0x2D, F3=0xA2 . . . ” and Device 250 may transmit “high-LTV: true, F1=0x01, F2=0x2D, F3=0xA2 . . . ”. In these examples, both the features' names and values are encrypted before being transmitted to Platform 210.

In some exemplary embodiments, a first learning phase may be implemented. During such learning phase, a generic on-device model may be trained. The generic on-device model may be based on raw data that is potentially sensitive, including data provided in rational data types. As an example, the generic on-device model may be configured to predict one or more segments of users of edge Devices 220-250. The generic on-device model may be trained at the cloud, on a server, or the like, and then be downloaded to each of edge Devices 220-250. In some exemplary embodiments, the generic on-device model may be trained based on information available to Platform 210. In some cases, the generic on-device model may be generic for all different apps supported by Platform 210. Additionally, or alternatively, several generic on-device model may be available, each for different potential usages or apps.

Additionally, or alternatively, a second learning phase may be implemented using app-specific data, for training app specific on-device models. Each app specific on-device model may be trained based on gathered information which is reported by one of the edge devices to Platform 210. As it might be desired to prevent Platform 210 from gaining access to the sensitive data, the reports may include generic information as well as app-specific labels. The generic information may be segments, predicted by the generic on-device model. As an example, the segments may indicate the demographic information of the user, current activity of the user (e.g., walking), trends of the users (e.g., walks less this week than usual), habits (e.g., walks often), or the like. Using the predicted information, together with an app-specific label, Platform 210 may train the app-specific on-device model to predict app-specific labels.

In some exemplary embodiments, the app-specific on-device model may be provided to each of edge Devices 220-250 in which it may be utilized in concatenation with the generic on-device model. The generic on-device model may predict the segments or other generic information about the edge device or its user. Such predicted information may be fed to the app specific on-device model to provide a prediction of the target labels. While the generic model can operate on any type of data, the app-specific on-device model may operate on categorized data types (e.g., segments outputted by the generic model) and not on rational data types. In such a case, the values of each feature may be encoded, encrypted, or the like. Additionally, or alternatively, the name or semantic meaning of each feature may be encoded, encrypted, or the like. Additionally or alternatively, in case the app-specific on-device model operates on a rational data type, the value of such data type may remain unchanged, or may be modified in a manner not affecting relationship between the different values of the data type (e.g., in a manner ensuring that relationship(x,y) iff relationship(encode(x), encode(y)).

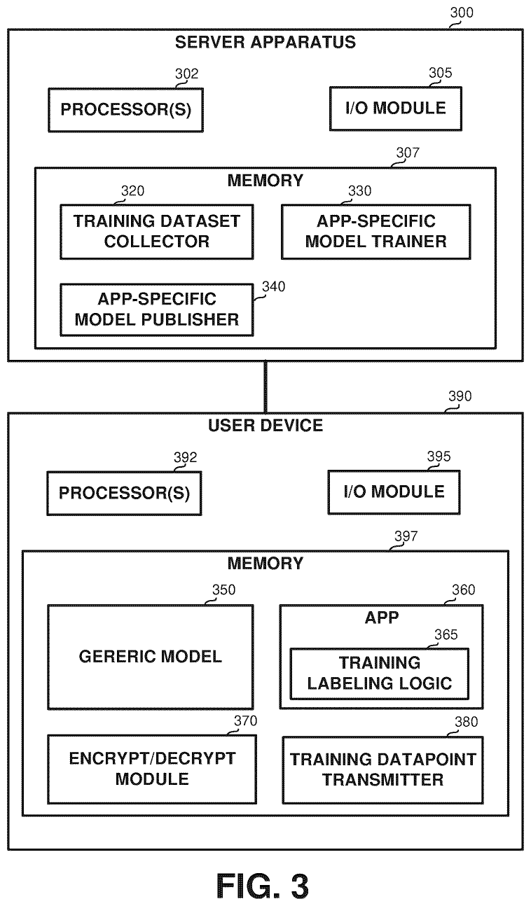

Referring now to FIG. 3 showing a block diagram of an apparatus, in accordance with some exemplary embodiments of the disclosed subject matter.

A Server Apparatus 300 may be configured to support parallel user interaction with a real-world physical system and a digital representation thereof, in accordance with the disclosed subject matter. Server Apparatus 300 may be utilized for training app-specific model in a computerized environment that comprises a plurality of user devices, such as User Device 390.

In some exemplary embodiments, Server Apparatus 300 may comprise one or more Processor(s) 302. Processor 302 may be a Central Processing Unit (CPU), a microprocessor, an electronic circuit, an Integrated Circuit (IC) or the like. Processor 302 may be utilized to perform computations required by Server Apparatus 300 or any of its subcomponents.

In some exemplary embodiments of the disclosed subject matter, Server Apparatus 300 may comprise an Input/Output (I/O) module 305. I/O Module 305 may be utilized to provide an output to and receive input from a plurality of user devices, such as, for example obtaining training data from User Device 390, providing app-specific models for user devices, or the like.

In some exemplary embodiments, Server Apparatus 300 may comprise Memory 307. Memory 307 may be a hard disk drive, a Flash disk, a Random-Access Memory (RAM), a memory chip, or the like. In some exemplary embodiments, Memory 307 may retain program code operative to cause Processor 302 to perform acts associated with any of the subcomponents of Server Apparatus 300.

A User Device 390 may be connected to Server Apparatus 300, may interact therewith via I/O Module 395, may be managed by Server Apparatus 300, or the like. In some exemplary embodiments, User Device 390 may comprise one or more Processor(s) 392. Processor 392 may be a Central Processing Unit (CPU), a microprocessor, an electronic circuit, an Integrated Circuit (IC) or the like. Processor 392 may be utilized to perform computations required by User Device 390 or any of its subcomponents. In some exemplary embodiments of the disclosed subject matter, User Device 390 may comprise an Input/Output (I/O) module 395. I/O Module 395 may be utilized to provide an output to and receive input from Server Apparatus 300, such as providing data, obtaining models, or the like.

In some exemplary embodiments, User Device 390 may comprise Memory 397. Memory 397 may be a hard disk drive, a Flash disk, a Random-Access Memory (RAM), a memory chip, or the like. In some exemplary embodiments, Memory 397 may retain program code operative to cause Processor 392 to perform acts associated with any of the subcomponents of User Device 390.

In some exemplary embodiments, a Generic Model 350 may be executed at User Device 390. Generic Model 350 may be trained offline before any of the apps are available. Generic Model 350 may be configured to classify a user of User Device 390 into one or more segments based on data obtained at User Device 390. Each segment of the one or more segments represents an audience segment that is characterized by one or more attributes.

In some exemplary embodiments, Training Dataset Collector 320 may be configured to obtain, via I/O Module 305, app-specific training sets, from apps installed on user devices, such as App 360 installed on User Device 390. The app-specific training sets collected by Training Dataset Collector 320 may be utilized by App-Specific Model Trainer 330 for training app-specific models to be utilized by the apps providing the training data. The app-specific training sets collected by, Training Dataset Collector 320 may comprise pairs of a ground truth label used by the application (e.g., App 360) and a respective set of segments of a user device (e.g., User Device 390) for which the ground truth label is deemed applicable by the application.

App-Specific Model Trainer 330 may be configured to train based on the training data collected by Training Dataset Collector 320, respective app-specific model. App-Specific Model Publisher 340 may be configured to the trained app-specific models to respective user devices, such as to User Device 390. The app-specific model may be configured to be utilized in concatenation with Generic Model 350, to predict a label for User Device 390 based on classification determined by Generic Model 350.

In some exemplary embodiments, Training Labeling Logic 365 may be configured to apply specific rules, algorithms, or processes to determine app-specific labels based on the segments identified by Generic Model 350. Training Labeling Logic 365 may be configured to take the output (user segments) from Generic Model 350 and apply logic to assign specific labels relevant to the domain or purpose of App 360.

During the training phase, Encryption/Decryption Module 370 may be configured to encrypt the training data, e.g., the pairs of user segments and app-specific labels, before transmitting it to the Server Apparatus 300 for model training, ensuring the privacy and security of the data. Encryption/Decryption Module 370 may be configured to either encrypt the app-specific labels generated by Training Labeling Logic 365, or the segments identified by Generic Model 350, the values or the names thereof, or any combination thereof. During inference or prediction phase, Encryption/Decryption Module 370 may be configured to it may also decrypt encrypted data received from Server Apparatus 300 to make predictions or classifications.

Training Datapoint Transmitter 380 may be configured to transmit training data points to Server Apparatus 300 for app-specific model training. Training Datapoint Transmitter 380 may be configured to interface with the Encryption/Decryption Module 370 to ensure that the training data is encrypted before transmission.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or user servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for training a first app-specific model in a computerized environment that comprises a plurality of user devices, the method comprising:
executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments;
obtaining, from a first application, a first training set to be used for training the first app-specific model, the first training set includes pairs of a ground truth label used by the first application and a respective set of segments of a user device for which the ground truth label is deemed applicable by the first application; and
training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.

2. The method of claim 1 further comprises:
obtaining, from a second application, a second training set to be used for training a second app-specific model, the second training set includes pairs of a ground truth label used by the second application and a respective set of segments of a user device for which the ground truth label is deemed applicable by the second application; and
training, based on the second training set, the second app-specific model, whereby the second app-specific model is configured to predict a label for a user device based on classification determined by the generic model without being privy to the data obtained at the each user device.

3. The method of claim 2, wherein the first app-specific model is configured to predict a first label for a specific user device, the second app-specific model is configured to predict a second label for the specific user device, wherein the first label and the second label are different.

4. The method of claim 2, wherein the first app-specific model and the second app-specific model are configured to predict a specific label of a same name, wherein the first app-specific model is configured to predict the specific label for a specific user device while the second app-specific model is configured to not predict the specific label for the specific device, whereby different label prediction is enabled for different applications.

5. The method of claim 4, wherein the specific label of the same name relates to at least one of Life Time Value (LTV) of a respective user, a churn likelihood of the respective user, and a promoter score of the respective user.

6. The method of claim 1, wherein the data obtained at each user device and utilized by the generic model comprises private data of the respective user of the each user device, whereby said training is performed without being privy to the private data, whereby the first app-specific model is configured to perform predictions without utilizing the private data directly.

7. The method of claim 6, wherein the private data comprises at least one of:
location data;
sensor reading data; and
browsing history data.

8. The method of claim 1, wherein said training the first app-specific model is performed on a cloud server, wherein in response to said training, the first application is configured to utilize the app-specific model in devices in which the first application is deployed.

9. The method of claim 1, wherein said training is performed on a computing device, the computing device is different than the plurality of user devices, wherein the respective set of segments utilized for training the first app-specific model is provided in an encrypted manner, whereby preventing the computing device from gaining access to confidential data of the first application.

10. The method of claim 9, wherein a value of a predicted segment is encrypted.

11. The method of claim 9, wherein a name of a predicted segment is encrypted

12. A system comprising:
a plurality of user devices, each individual user device of said plurality of user devices executing a generic model, the generic model being configured to classify a user of the each individual user device into one or more segments based on data obtained at the each individual user device, each segment of the one or more segments represents an audience segment that is characterized by one or more attributes, whereby each user device is potentially classified into a different set of segments;
a server configured to obtain data from said plurality of user devices and train app-specific models to be utilized by said plurality of user devices, wherein said server is configured to:
obtain, from an application executed on at least a portion of the plurality of user devices, a training set to be used for training an app-specific model, the training set includes pairs of a ground truth label used by the application and a respective set of segments of user devices for which the ground truth label is deemed applicable by the application; and
train, based on the training set, the app-specific model, wherein the app-specific model is configured to be utilized in concatenation with the generic model, the app-specific model is configured to predict a label for a user device based on classification determined by the generic model without being privy to the data obtained at the user device.

13. A computerized apparatus having a hardware processor, the hardware processor being coupled to a memory, the hardware processor being adapted to perform the steps of:
executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments;
obtaining, from a first application, a first training set to be used for training the first app-specific model, the first training set includes pairs of a ground truth label used by the first application and a respective set of segments of a user device for which the ground truth label is deemed applicable by the first application; and
training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.

14. The computerized apparatus of claim 13, wherein the hardware processor is further adapted to perform the steps of:
obtaining, from a second application, a second training set to be used for training a second app-specific model, the second training set includes pairs of a ground truth label used by the second application and a respective set of segments of a user device for which the ground truth label is deemed applicable by the second application; and
training, based on the second training set, the second app-specific model, whereby the second app-specific model is configured to predict a label for a user device based on classification determined by the generic model without being privy to the data obtained at the each user device.

15. The computerized apparatus of claim 14, wherein the first app-specific model is configured to predict a first label for a specific user device, the second app-specific model is configured to predict a second label for the specific user device, wherein the first label and the second label are different.

16. The computerized apparatus of claim 14, wherein the first app-specific model and the second app-specific model are configured to predict a specific label of a same name, wherein the first app-specific model is configured to predict the specific label for a specific user device while the second app-specific model is configured to not predict the specific label for the specific device, whereby different label prediction is enabled for different applications.

17. The computerized apparatus of claim 13, wherein the data obtained at each user device and utilized by the generic model comprises private data of the respective user of the each user device, whereby said training is performed without being privy to the private data, whereby the first app-specific model is configured to perform predictions without utilizing the private data directly.

18. The computerized apparatus of claim 13, wherein said training the first app-specific model is performed on a cloud server, wherein in response to said training, the first application is configured to utilize the app-specific model in devices in which the first application is deployed.

19. The computerized apparatus of claim 13, wherein said training is performed on a computing device, the computing device is different than the plurality of user devices, wherein the respective set of segments utilized for training the first app-specific model is provided in an encrypted manner, whereby preventing the computing device from gaining access to confidential data of the first application.

20. A computer program product comprising a non-transitory computer readable storage medium retaining program instructions, which program instructions when read by a processor, cause the processor to perform a method comprising:
executing, at each user device of the plurality of user devices a generic model, the generic model is configured to classify a user of the each user device into one or more segments based on data obtained at the each user device, each segment of the one or more segments represents an audience segment that is characterized by one or more attributes, whereby each user device is potentially classified into a different set of segments;
obtaining, from a first application, a first training set to be used for training the first app-specific model, the first training set includes pairs of a ground truth label used by the first application and a respective set of segments of a user device for which the ground truth label is deemed applicable by the first application; and
training, based on the first training set, the first app-specific model, wherein the first app-specific model is configured to be utilized in concatenation with the generic model, the first app-specific model is configured to predict a label for a user device based on classification determined by the generic model without being privy to the data obtained at the each user device.
